(19) United States
(12) Patent Application Publication
(10) Pub. No.: US 2025/0224952 A1
(43) Pub. Date: Jul. 10, 2025

(54) ELECTRONIC APPARATUS, METHOD OF CONTROLLING THE SAME, AND STORAGE MEDIUM

(71) Applicant: CANON KABUSHIKI KAISHA, Tokyo (JP)

(72) Inventors: MASAYUKI OGAWA, Kanagawa (JP); SOICHIRO KATAYAMA, Kanagawa (JP)

(21) Appl. No.: 19/005,142

(22) Filed: Dec. 30, 2024

(30) Foreign Application Priority Data
Jan. 5, 2024 (JP) 2024-000571

(51) Int. Cl. G06F 8/65; H04N 1/32

(52) U.S. Cl. CPC G06F 8/65; H04N 1/3208

(57) ABSTRACT

An electronic apparatus comprising at least one memory storing a program and at least one processor, which when executing the program, causes the electronic apparatus to receive a first instruction for enabling a first operation mode and a second instruction for enabling a second operation mode, and perform, in the first operation mode even without a communication instructing operation by a user after the first instruction, control to communicate with a first communication destination and control to communicate with a second communication destination for a firmware update, and perform, in the second operation mode, control to restrict the communication with the first communication destination and control to communicate with the second communication destination even without the communication instructing operation by the user after the second instruction.

### BACKGROUND

### Field

The present disclosure relates to an electronic apparatus, a method of controlling the electronic apparatus, and a storage medium.

### Description of the Related Art

There have been cases where an apparatus is shut down due to a communication failure, such as a program failure of the apparatus during the connection to a web server. The shutdown of the apparatus immediately after a startup makes it impossible to provide a user with even a service not involving connection to the web server. To solve this issue, there is a known method that reduces communication failures by a start of the apparatus in a mode (a safe mode) for prohibiting (limiting) an automatic network connection using a startup operation different from the normal startup operation to provide the user with a service not involving the network connection.

Japanese Patent Application Laid-Open No. 2017-194833 discusses that when a predetermined restart target error is issued in response to an inconvenience of an image forming apparatus not normally being started even with restart processing being performed, the restart processing is performed with the network port(s) used for communication with external devices disabled.

When the apparatus is started in the mode for limiting the communication, and then a new firmware is released with the failure factor(s) eliminated, the user manually downloads the new firmware, performs the firmware update, and restarts the apparatus. This enables the automatic network connection again, and the user to use functions involving communication (e.g., web service). However, when the apparatus is started in the mode for limiting the communication, information about the release of the new firmware will not be automatically received since the automatic communication connection is limited. Not knowing the release of the new firmware with the failure factor(s) eliminated, the user cannot update the firmware to clear the failure, and unusable functions in the limited communication will remain unusable. Even when the user obtains the information about the release of the new firmware without the failure factor(s) through information on the Web or a call center, a manual download of the latest firmware is performed by the user, which is troublesome.

### SUMMARY OF THE INVENTION

The present disclosure is directed to a mechanism that more appropriately clears communication failures while reducing such failures.

According to an aspect of the present invention, an electronic apparatus comprising at least one memory storing a program and at least one processor, which when executing the program, causes the electronic apparatus to receive a first instruction for enabling a first operation mode and a second instruction for enabling a second operation mode, and to perform, in the first operation mode even without a communication instructing operation by a user after the first instruction, control to communicate with a first communication destination and control to communicate with a second communication destination for a firmware update, and to perform, in the second operation mode, control to restrict the communication with the first communication destination and control to communicate with the second communication destination even without the communication instructing operation by the user after the second instruction.

Further features of the present disclosure will become apparent from the following description of exemplary embodiments with reference to the attached drawings.

### BRIEF DESCRIPTION OF THE DRAWINGS

FIG. 1 is a diagram illustrating a configuration example of a printing system.

FIG. 2 is a block diagram illustrating a hardware configuration example of a printer.

FIGS. 3A to 3C are a flowchart illustrating a method of controlling the printer.

FIGS. 4A to 4C are diagrams each illustrating an example of a display screen.

### DESCRIPTION OF THE EMBODIMENTS

Exemplary embodiments will now be described with reference to the drawings. Appropriate changes and improvements of the exemplary embodiments, which will be described, based on general knowledge of those skilled in the art without departing from the spirit of the present disclosure are also included in the scope of the exemplary embodiments.

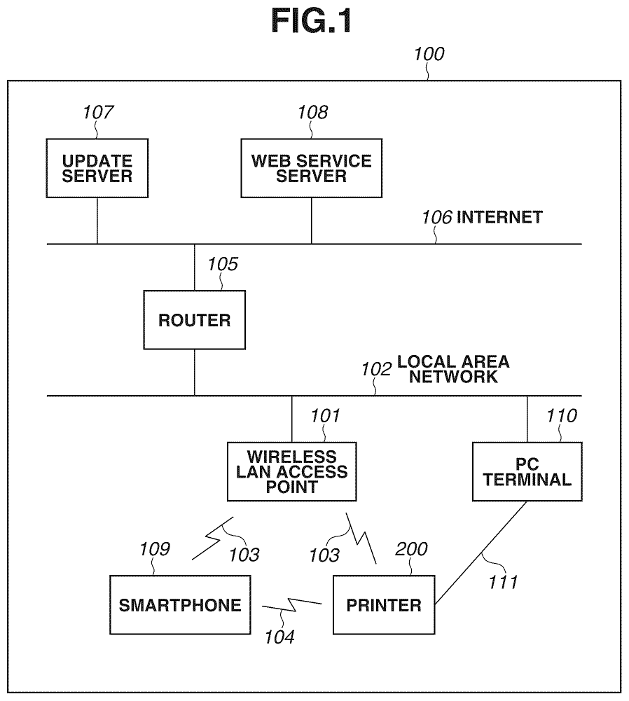

A first exemplary embodiment will be described. FIG. 1 is a diagram illustrating a configuration example of a printing system 100 according to the first exemplary embodiment. The printing system 100 includes a wireless local area network (LAN) access point 101, a router 105, an update server 107, a web service server 108, a smartphone 109, a personal computer (PC) terminal 110, and a printer 200.

The router 105, the update server 107, and the web service server 108 are connected to the Internet 106. The router 105, the wireless LAN access point 101, and the PC terminal 110 are connected to a local area network 102.

The printer 200 and the smartphone 109 are each wirelessly connected to the wireless LAN access point 101 to be connected to the local area network 102. Connections between the printer 200 and the wireless LAN access point 101 and between the smartphone 109 and the wireless LAN access point 101 use a wireless LAN infrastructure-mode connection 103.

The printer 200 includes a mode in which the printer 200 itself operates as a wireless LAN access point. When the printer 200 operates as the wireless LAN access point, the smartphone 109 can be directly connected to the wireless LAN access point of the printer 200. The connection is referred to as a wireless direct connection 104.

Other apparatuses, such as the PC terminal 110, can be connected to the local area network 102. The local area network 102 is connected via the router 105 to the Internet 106.

The printer 200, the smartphone 109, and the PC terminal 110 can communicate via the router 105 to the web service server 108 and the update server 107 on the Internet 106.

The printer 200 includes a universal serial bus (USB) connection terminal, and can establish USB connections to various kinds of apparatuses. The printer 200 is connected to the PC terminal 110 with a USB cable 111.

The configuration is merely an example. Even when the system has a different configuration, the effect of the present exemplary embodiment remains unchanged. For example, in FIG. 1, the wireless LAN access point 101 and the router 105 are provided as different apparatuses. However, one router apparatus including an access point function can be provided.

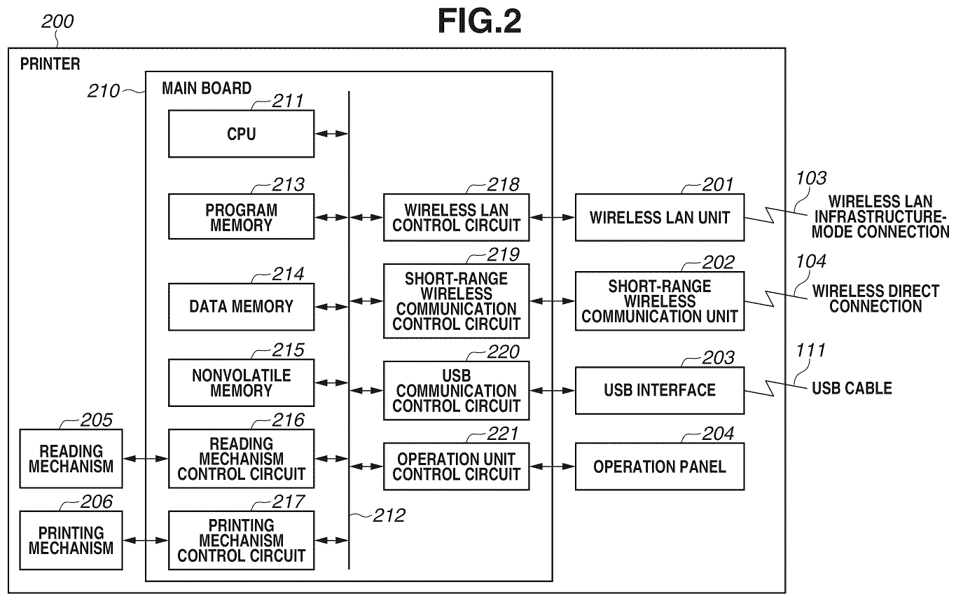

FIG. 2 is a block diagram illustrating a hardware configuration example of the printer 200 illustrated in FIG. 1. The printer 200 includes a wireless LAN unit 201, a short-range wireless communication unit 202, a USB interface 203, an operation panel 204, a reading mechanism 205, a printing mechanism 206, and a main board 210.

The main board 210 includes a central processing unit (CPU) 211, an internal bus 212, a program memory 213, a data memory 214, a nonvolatile memory 215, a reading mechanism control circuit 216, and a printing mechanism control circuit 217. The main board 210 further includes a wireless LAN control circuit 218, a short-range wireless communication control circuit 219, a USB communication control circuit 220, and an operation unit control circuit 221.

The main board 210 controls the printer 200. The CPU 211 as a microprocessor disposed on the main board 210 operates based on control programs stored in the program memory 213 as a read only memory (ROM) and contents of the data memory 214 as a random access memory (RAM) that are connected via the internal bus 212.

In addition, the main board 210 includes the nonvolatile memory 215 that can hold contents even when power is not supplied. The CPU 211 writes various kinds of setting values and data in the nonvolatile memory 215. When the power turns off temporarily and then the operation is started again with the power supplied, the CPU 211 continues the operation based on the same set values and data.

Examples of the nonvolatile memory 215 include a semiconductor storage device, such as a flash memory. A flash memory can maintain stored contents even when energization is stopped, but the number of rewrites on each memory device is limited in most cases.

Thus, the printer 200 is designed in consideration of writing timings to the nonvolatile memory 215 during its product lifetime. It is generally estimated that storage devices with a guaranteed large number of rewrites cost more per component.

The CPU 211 controls the reading mechanism 205 through the reading mechanism control circuit 216 to read a document and store image data information in the data memory 214.

The CPU 211 controls the printing mechanism 206 through the printing mechanism control circuit 217 to print image data in the data memory 214 on a recording medium (sheet).

The CPU 211 controls the wireless LAN unit 201 through the wireless LAN control circuit 218 to perform wireless LAN communication with another communication terminal apparatus through the wireless LAN infrastructure-mode connection 103.

The CPU 211 controls the short-range wireless communication unit 202 through the short-range wireless communication control circuit 219 to detect the connection to another short-range wireless communication terminal and communicate data with another short-range wireless communication terminal through the wireless direct connection 104.

The CPU 211 operates the USB interface 203 through the USB communication control circuit 220, and performs USB communication with another terminal apparatus connected through the USB cable 111.

The CPU 211 controls the operation unit control circuit 221, enabling displays of the state of the printer 200 and a function selection menu on the operation panel 204, and reception of user operations.

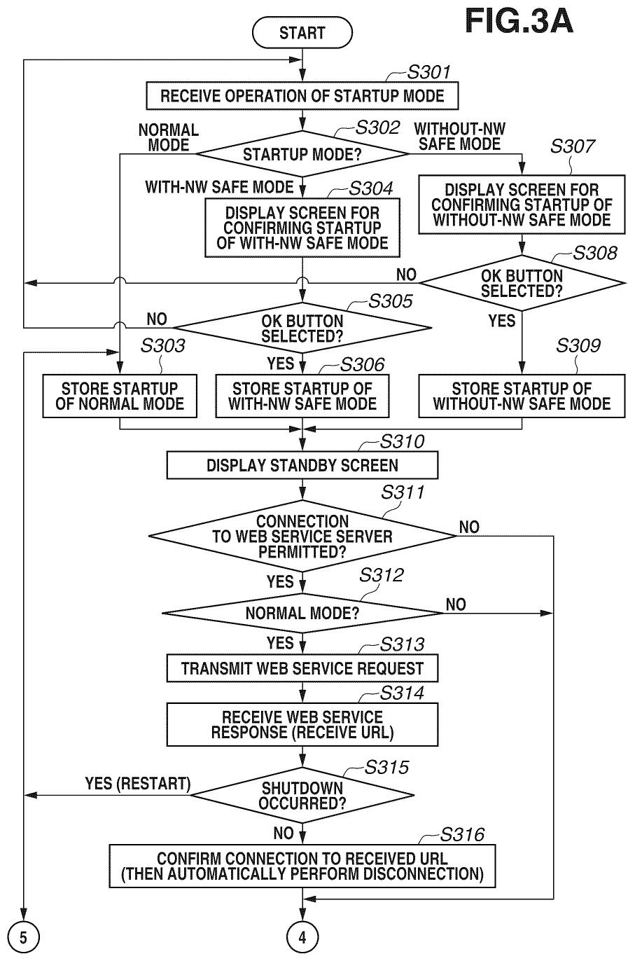

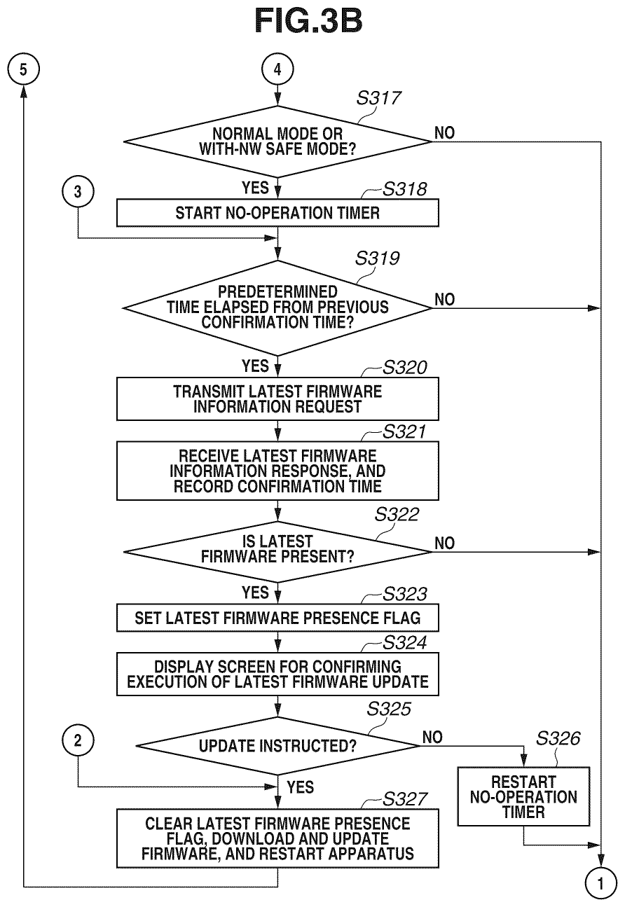

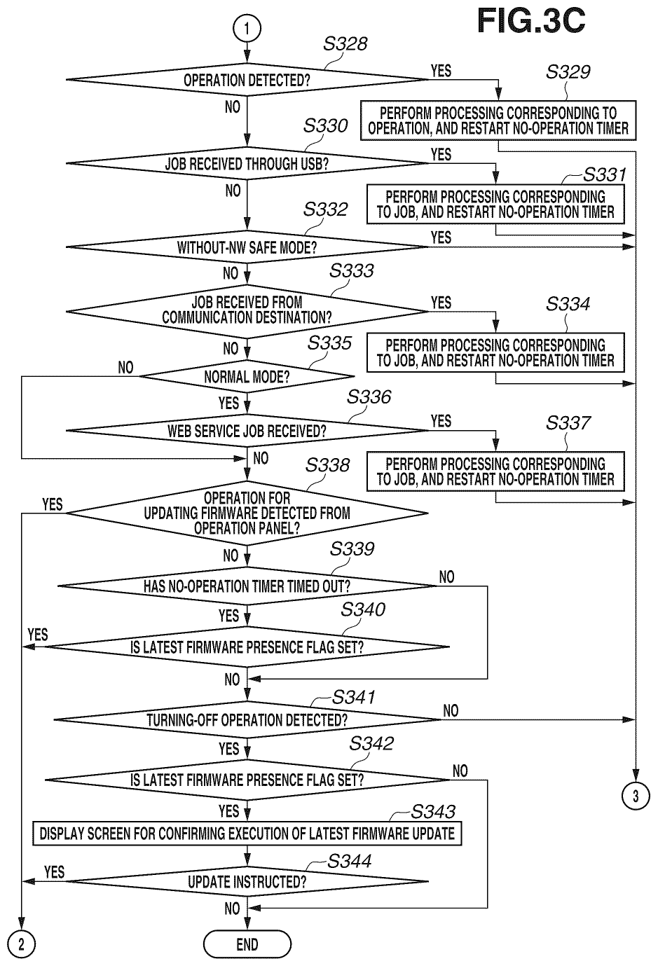

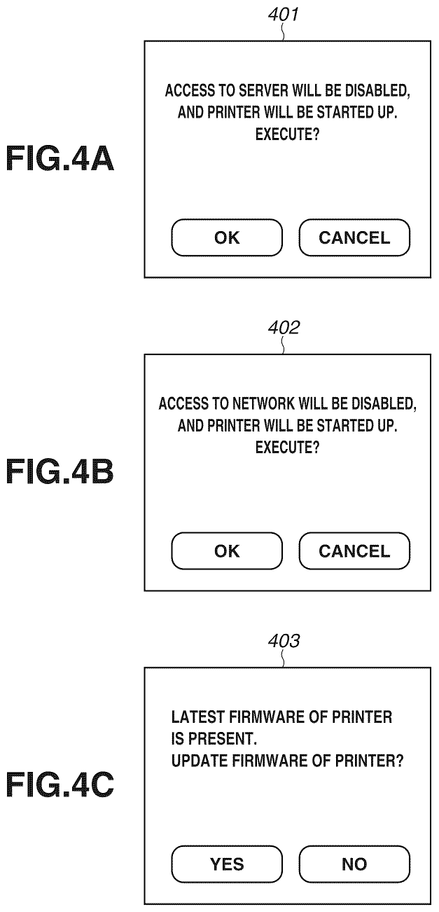

A procedure will now be described for changing a service to be provided based on a mode started by operation at the startup of the printer 200 according to the present exemplary embodiment, and updating the firmware when latest firmware is detected with reference to FIGS. 3A to 3C. Display screens displayed on the printer 200 will be described with reference to FIGS. 4A to 4C.

FIGS. 3A to 3C are a flowchart illustrating a method of controlling the printer 200 according to the present exemplary embodiment. The processing in the flowchart illustrated in FIGS. 3A to 3C is performed when the CPU 211 loads programs recorded in the program memory 213 into the data memory 214, and executes the programs.

The printer 200 is an example of an electronic apparatus.

In step S301, the CPU 211 receives an operation for a startup mode from a user through the operation panel 204. The CPU 211 functions as a reception unit, and can receive startup instructions of a normal mode for enabling the normal mode, of a safe mode with a network (NW) for the safe mode with an NW, and of a safe mode without an NW for the safe mode without an NW. The normal mode, the safe mode with an NW, and the safe mode without an NW are examples of a normal operation mode, a safe operation mode with an NW, and a safe operation mode without an NW, respectively. The CPU 211 receives, via the operation panel 204, operations of different operation methods as the startup instructions of the normal mode, the safe mode with an NW, and the safe mode without an NW.

In step S302, the CPU 211 determines the type of the startup mode received in step S301.

If the startup mode is the normal mode (NORMAL MODE in step S302), the processing proceeds to step S303. If the startup mode is the safe mode with an NW (WITH-NW SAFE MODE in step S302), the processing proceeds to step S304. If the startup mode is the safe mode without an NW (WITHOUT-NW SAFE MODE in step S302), the processing proceeds to step S307.

In step S303, the CPU 211 stores the startup of the normal mode in the data memory 214. The processing then proceeds to step S310.

In step S304, since the startup mode is the safe mode with an NW, the CPU 211 controls the operation panel 204 to display a display screen 401 illustrated in FIG. 4A for displaying a message indicating that the access to the server will be disabled and for obtaining a permission of the startup.

In step S305, the CPU 211 determines whether the user selects the OK button or the CANCEL button on the display screen 401 in the operation panel 204. If the user selects the OK button (YES in step S305), the processing proceeds to step S306. If the user selects the CANCEL button (NO in step S305), the safe mode with an NW is not started, and the processing proceeds to step S301.

In step S306, the CPU 211 stores the startup of the safe mode with an NW in the data memory 214. The processing then proceeds to step S310.

In step S307, since the startup mode is the safe mode without an NW, the CPU 211 controls the operation panel 204 to display a display screen 402 illustrated in FIG. 4B for displaying a message indicating that the access to the network will be disabled and for obtaining a permission of the startup.

In step S308, the CPU 211 determines whether the user selects the OK button or the CANCEL button on the display screen 402 in the operation panel 204. If the user selects the OK button (YES in step S308), the processing proceeds to step S309. If the user selects the CANCEL button (NO in step S308), the safe mode without an NW is not started, and the processing proceeds to step S301.

In step S309, the CPU 211 stores a startup of the safe mode without an NW in the data memory 214. The processing then proceeds to step S310.

In step S310, the CPU 211 controls the operation panel 204 to display a standby screen indicating the completion of initialization of the printer 200.

The first access to the web service server 108 is enabled at the timing when the display screen is changed to the standby screen. The CPU 211 does not display on the standby screen information indicating whether the startup mode is the safe mode with an NW or the safe mode without an NW.

In step S311, the CPU 211 determines whether the connection to the web service server 108 has been permitted at a startup before the startup in the current procedure, from information in the nonvolatile memory 215. If the connection to the web service server 108 has been permitted (YES in step S311), the processing proceeds to step S312. If the connection to the web service server 108 has not been permitted (NO in step S311), the processing proceeds to step S317.

In step S312, the CPU 211 determines whether the startup mode is the normal mode based on the startup mode stored in the data memory 214 in step S303, S306, or S309. If the startup mode is the normal mode (YES in step S312), the processing proceeds to step S313. If the startup mode is not the normal mode (NO in step S312), the processing proceeds to step S317.

In step S313, the CPU 211, which serves as a HyperText Transfer Protocol (HTTP) client in HTTP communication, performs a control to transmit a web service request to the web service server 108 using the wireless LAN unit 201. The web service server 108 is a communication destination to be communicated to use of a function using a web service.

In step S314, the CPU 211 performs a control to receive a response to the web service request transmitted in step S313 from the web service server 108 via the HTTP communication using the wireless LAN unit 201. The received response can include the designation of the uniform resource locator (URL) of a new connection destination. The CPU 211 performs a control to perform a connection to the designated URL.

At this time, if a failure, such as breakage of the data memory 214, occurs because the URL having a size greater than an estimated size of the URL is received depending on the program, and a normal operation cannot be performed thereafter, the CPU 211 performs a control to shut down the apparatus.

As described above, in steps S313 and S314, in the normal mode, the CPU 211 functions as a control unit, and performs control to communicate with the web service server 108 as the communication destination even without a communication instructing operation by the user after the instruction in step S301.

In the safe mode with an NW, the determination in step S312 results in NO, so that the processing in steps S313 and S314 is not performed. Thus, the CPU 211 performs control to restrict communication with the web service server 108 as the communication destination.

In step S315, the CPU 211 determines whether to perform a shutdown. If the shutdown is performed (YES in step S315), the processing proceeds to step S303. If the shutdown is not performed (NO in step S315), the processing proceeds to step S316.

In step S316, the CPU 211 confirms the connection to the URL received in step S314 via the HTTP communication using the wireless LAN unit 201. Thereafter, the CPU 211 automatically performs a disconnection.

In step S317, the CPU 211 determines whether the startup mode is the normal mode or the safe mode with an NW based on the startup mode stored in the data memory 214. If the startup mode is the normal mode or the safe mode with an NW (YES in step S317), the processing proceeds to step S318. If the startup mode is neither the normal mode nor the safe mode with an NW, namely, if the startup mode is the safe mode without an NW (NO in step S317), the processing proceeds to step S328.

In step S318, the CPU 211 starts a no-operation timer. The no-operation timer monitors whether the user does not operate the operation panel 204 or no request is issued for execution of a printing or reading job from the wireless LAN infrastructure-mode connection 103, the wireless direct connection 104, or the USB cable 111. If latest firmware is provided in the update server 107 at the timeout of the no-operation timer, the CPU 211 automatically downloads the latest firmware from the update server 107, and updates the program memory 213 with the latest firmware.

In step S319, the CPU 211 determines whether a predetermined time has elapsed since the confirmation time, based on the current time and the previous confirmation time of the detection of latest firmware in the update server 107 stored in the nonvolatile memory 215. If the predetermined time has elapsed (YES in step S319), the processing proceeds to step S320. If the predetermined time has not elapsed (NO in step S319), the processing proceeds to step S328.

The condition in step S319 is an example of a predetermined condition. If the predetermined condition is satisfied, the processing proceeds to step S320. The predetermined condition is, for example, a condition relating to a time, and is at least one of the lapse of a predetermined period, the arrival at a predetermined time point (e.g., 7:00 a.m. on every Monday), and the continuation of a no-operation state for a predetermined time.

This configuration enables the CPU 211 to periodically collect information about the presence or absence of the latest firmware in the background. The above-described predetermined time is, for example, one week from the last collection. In the time of reception, the above-described predetermined time is 24 hours from the end of reception processing. The elapsed time of collection is counted even while the software is disabled.

In step S320, the CPU 211, which serves as an HTTP client in the HTTP communication, transmits a latest firmware information request to the update server 107 with the wireless LAN unit 201.

In step S321, the CPU 211 receives the latest firmware information as a response to the latest firmware information request transmitted in step S320 via the HTTP communication using the wireless LAN unit 201 from the update server 107. The CPU 211 stores the reception time in the nonvolatile memory 215. The time stored here is used as the confirmation time in step S319.

As described above, in steps S320 and S321, the CPU 211 performs control to communicate with the update server 107 as the communication destination for firmware update even without an instruction of communication operation by the user after the instruction in step S301. More specifically, the CPU 211 performs a control to acquire, as the latest firmware information, information indicating whether there is firmware of a version newer than the current firmware of the printer 200.

In step S322, the CPU 211 determines whether the latest firmware is in the update server 107 in comparison between the latest firmware information received in step S321 and the information in the program memory 213. If the latest firmware is in the update server 107 (YES in step S322), the processing proceeds to step S323. If the latest firmware is not in the update server 107 (NO in step S322), the processing proceeds to step S328. In other words, if information indicating the presence of the firmware of a new version is acquired, the processing proceeds to step S323.

In step S323, the CPU 211 sets a latest firmware presence flag stored in the nonvolatile memory 215.

In step S324, the CPU 211 controls the operation panel 204 to display a display screen 403 illustrated in FIG. 4C for obtaining the permission of an update with the latest firmware. The display screen 403 is an example of a check screen for confirming whether to perform the firmware update.

If the latest firmware presence flag is set, the CPU 211 displays a message “There is latest firmware.” even when the software is disabled, and guides the user to the update as with the display screen 403.

In step S325, the CPU 211 determines whether the user selects the YES button for permitting the update or the NO button on the display screen 403 in the operation panel 204. If the user selects the YES button (YES in step S325), the processing proceeds to step S327. If the user selects the NO button (NO in step S325), the processing proceeds to step S326. If the CPU 211 receives an execution instruction of a firmware update operation from the user with the display screen 403 being displayed, the processing proceeds to step S327.

In step S326, the CPU 211 restarts the no-operation timer. The processing then proceeds to step S328.

If the latest firmware presence flag is cleared in step S323, the CPU 211 notifies the presence of the latest firmware in response to a state inquiry to the printer 200 from the smartphone 109 connected through the wireless LAN unit 201 or the PC terminal 110. In response to the notification, the smartphone 109 or the PC terminal 110 asks the user to permit the update of the latest firmware. When the update is permitted, the CPU 211 can receive an update request from the smartphone 109 or the PC terminal 110, and update to the latest firmware.

In step S327, the CPU 211 clears the latest firmware presence flag stored in the nonvolatile memory 215. The CPU 211, which serves as the HTTP client in the HTTP communication, transmits a latest firmware download request to the update server 107 with the wireless LAN unit 201. The CPU 211 receives download data about the latest firmware from the update server 107, updates the information in the program memory 213 with the download data, and restarts the apparatus. The processing then proceeds to step S303.

In other words, the CPU 211 performs a control to perform the update processing with the firmware of a new version.

When the latest firmware presence flag is set, the CPU 211 can perform an update by indication from the smartphone 109 or the PC terminal 110.

In the safe mode with an NW, in response to the startup of the safe mode with an NW, the CPU 211 can perform control to communicate with the update server 107 as the communication destination in steps S320 to S327 even without an instruction of communication operation by the user after the instruction in step S301. In other words, in the safe mode with an NW, the CPU 211 can perform the processing in steps S320 to S327 at the same timing as that in step S306.

In step S328, the CPU 211 determines whether an operation from the operation panel 204 is detected. If the operation is detected (YES in step S328), the processing proceeds to step S329. If the operation is not detected (NO in step S328), the processing proceeds to step S330.

In step S329, the CPU 211 performs processing based on the operation with the reading mechanism 205 or the printing mechanism 206. After the processing is completed, the CPU 211 restarts the no-operation timer. The processing then proceeds to step S319.

If the startup mode stored in the data memory 214 is the normal mode or the safe mode with an NW, the CPU 211 can change network settings (e.g., a service set identifier (SSID) of the wireless LAN access point 101, a password setting, and a security system). In contrast, if the startup mode is the safe mode without an NW, the CPU 211 cannot change the network settings.

In step S330, the CPU 211 determines whether a job execution request is received from the communication destination, such as the PC terminal 110, connected through a USB cable using the USB interface 203. The PC terminal 110 is an example of an information processing apparatus. If the job execution request is received (YES in step S330), the processing proceeds to step S331. If the job execution request is not received (NO in step S330), the processing proceeds to step S332.

In step S331, the CPU 211 performs processing based on the received job execution request with the reading mechanism 205 or the printing mechanism 206. After the processing is completed, the CPU 211 restarts the no-operation timer. Thereafter, the processing proceeds to step S319. The CPU 211 performs control to perform, for example, a printing in response to a printing instruction or processing for performing a scan and transmitting the scan data to the PC terminal 110.

In step S332, the CPU 211 determines whether the startup mode stored in the data memory 214 is the safe mode without an NW. If the startup mode is the safe mode without an NW (YES in step S332), the processing proceeds to step S319. If the startup mode is the normal mode or the safe mode with an NW (NO in step S332), the processing proceeds to step S333.

In step S333, the CPU 211 determines whether a job execution request is received from the communication destination, such as the smartphone 109, with the wireless LAN unit 201 or the short-range wireless communication unit 202. The smartphone 109 is an example of the information processing apparatus. In a case of using the wireless LAN unit 201, the communication destination of the printer 200 is the smartphone 109 connected to the same wireless LAN access point 101 through the wireless LAN infrastructure-mode connection 103. In a case of using the short-range wireless communication unit 202, the communication destination of the printer 200 is the smartphone 109 connected through the wireless direct connection 104. If the job execution request is received (YES in step S333), the processing proceeds to step S334. If the job execution request is not received (NO in step S333), the processing proceeds to step S335.

In step S334, the CPU 211 performs processing based on the received job execution request with the reading mechanism 205 or the printing mechanism 206. After the processing is completed, the CPU 211 restarts the no-operation timer. Thereafter, the processing proceeds to step S319. The CPU 211 performs control to perform, for example, a printing in response to a printing instruction or processing for performing a scan and transmitting the scan data to the smartphone 109.

In the safe mode with an NW, the job received through the network can be executed in step S333. However, a job is basically prohibited on which the printing is performed with the printer 200 as a client in such a manner that connects to the web service server 108 through the HTTP communication. However, the HTTP communication for firmware update is permitted as in steps S320 and S327.

In step S335, the CPU 211 determines whether the startup mode stored in the data memory 214 is the normal mode. If the startup mode is the normal mode (YES in step S335), the processing proceeds to step S336. If the startup mode is the safe mode with an NW (NO in step S335), the processing proceeds to step S338.

In step S336, the CPU 211 determines whether a job execution request is received from the web service server 108 with the wireless LAN unit 201. If the job execution request is received (YES in step S336), the processing proceeds to step S337. If the job execution request is not received (NO in step S336), the processing proceeds to step S338.

In step S337, the CPU 211 performs processing based on the received job execution request with the reading mechanism 205 or the printing mechanism 206. After the processing is completed, the CPU 211 restarts the no-operation timer. The processing then proceeds to step S319.

In step S338, the CPU 211 determines whether the operation of a firmware update request from the operation panel 204 is detected. If the operation is detected (YES in step S338), the processing proceeds to step S327 to update the latest firmware. If the operation is not detected (NO in step S338), the processing proceeds to step S339.

In step S339, the CPU 211 determines whether the no-operation timer has timed out. The time-out of the no-operation timer is set to, for example, ten minutes, and the time-out indicates that no operation is performed for a predetermined period. If the no-operation timer has timed out (YES in step S339), the processing proceeds to step S340. If the no-operation timer has not timed out (NO in step S339), the processing proceeds to step S341.

In step S340, the CPU 211 determines whether the latest firmware presence flag stored in the nonvolatile memory 215 is set. If the latest firmware presence flag is set (YES in step S340), the processing proceeds to step S327 to update the latest firmware. If the latest firmware presence flag is not set (NO in step S340), the processing proceeds to step S341.

In step S341, the CPU 211 determines whether a turning-off request operation from the operation panel 204 is detected. If the operation is detected (YES in step S341), the processing proceeds to step S342. If the operation is not detected (NO in step S341), the processing proceeds to step S319.

In step S342, the CPU 211 determines whether the latest firmware presence flag stored in the nonvolatile memory 215 is set. If the latest firmware presence flag is set (YES in step S342), the processing proceeds to step S343. If the latest firmware presence flag is not set (NO in step S342), the CPU 211 performs the turning-off processing, and the processing in the flowchart ends.

In step S343, the CPU 211 controls the operation panel 204 to display the display screen 403 illustrated in FIG. 4C for obtaining permission of update with the latest firmware.

In step S344, the CPU 211 determines whether the user selects the YES button for permitting the update on the display screen 403 in the operation panel 204. If the user selects the YES button (YES in step S344), the processing proceeds to step S327 to update the latest firmware. If the user selects the NO button (NO in step S344), the CPU 211 performs the turning-off processing. The processing in the flowchart then ends.

The effect of the present exemplary embodiment will now be described. In the safe mode with an NW, the web service request is not transmitted in step S313 (communication with the communication destination for web service is restricted), preventing a shutdown caused by an unintended response. In other words, communication failures can be reduced.

On the other hand, functions other than the web service, for example, copy jobs, scan jobs, jobs received through a USB, and jobs received in a network (e.g., jobs received from a PC connected to the same access point as that of the printer 200 or a PC directly connected thereto) can be performed. Thus, most of the functions of the printer 200 are usable.

In steps S322 to S324, the CPU 211 automatically performs communication to acquire the information indicating whether the latest firmware is released. This makes it possible to avoid a situation where the user does not notice a release of the latest firmware and miss the update.

With the latest firmware released, if the update instruction is issued by the user (YES in step S325), the update processing itself is performed while no operation is performed (YES in step S339 and YES in step S340) or the turning-off processing is performed (YES in step S341, YES in step S342, and YES in step S344). Thus, it is possible to prevent the update processing from inhibiting a copy task and a scan task performed with the user's instructions.

When the update processing is performed, the apparatus is automatically restarted in the normal mode (S327 and S303). In addition, it is expected for a failure factor or failure factors causing the determination result in step S315 as YES to be eliminated. If firmware by which the factor(s) of the communication failure is or are eliminated is downloadable after a startup in the safe mode with an NW after a communication failure occurs, the user can download and update to the new firmware without forgetting and troublesome operations, making it possible for the apparatus to be used in the normal mode with the failure cleared. Thus, the apparatus can suitably return to a state where services involving communication with the web service are usable.

The above-described various kinds of control performed by the CPU 211 can be performed by a piece of hardware. The apparatus can be generally controlled by a plurality of hardware (e.g., plurality of processors and circuits) sharing the processing.

While the present disclosure has been described in detail based on the exemplary embodiment, the present disclosure is not limited to the specific exemplary embodiment, and various forms without departing from the spirit of the present disclosure are also included in the present disclosure. The above-described exemplary embodiment is merely one exemplary embodiment of the present disclosure, and the exemplary embodiments can be appropriately combined.

In the above-described exemplary embodiment, a case where the present disclosure is applied to the printer 200 is described as an example. However, this example is not limiting, and the present disclosure is applicable to an electronic apparatus in which the firmware can be updated. Specifically, the present disclosure is applicable to a personal computer, a personal digital assistant (PDA), a mobile phone terminal, a portable image viewer, a digital photo frame, a music player, a game machine, an electronic book reader, and a home electric appliance, for example.

### Other Exemplary Embodiments

The present disclosure can also be implemented by software (programs) carrying out the functions of the above-described exemplary embodiment applied to a system or an apparatus through a network or various kinds of recording media, and causing a computer (or a CPU, or a microprocessor unit (MPU), etc.) in the system or the apparatus to read and execute program codes. In this case, the programs and a recording medium that records the programs are included in the present disclosure.

The above-described exemplary embodiments are merely specific examples for implementation of the present disclosure, and a technical scope of the present disclosure is not interpreted in a limited manner by the exemplary embodiments. In other words, the present disclosure can be implemented in various forms without departing from the technical idea or the main features of the present disclosure.

According to the exemplary embodiments, more suitable elimination of failures caused by communication can be performed while reducing such failures.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-000571, filed Jan. 5, 2024, which is hereby incorporated by reference herein in its entirety.

What is claimed is:

1. An electronic apparatus comprising:
at least one memory storing a program; and
at least one processor, which when executing the program, causes the electronic apparatus to:
receive a first instruction for enabling a first operation mode and a second instruction for enabling a second operation mode; and
perform, in the first operation mode even without a communication instructing operation by a user after the first instruction, control to communicate with a first communication destination and control to communicate with a second communication destination for a firmware update, and
perform, in the second operation mode, control to restrict the communication with the first communication destination and perform control to communicate with the second communication destination even without the communication instructing operation by the user after the second instruction.

2. The electronic apparatus according to claim 1, wherein the first instruction and the second instruction are both a startup instruction of the electronic apparatus.

3. The electronic apparatus according to claim 1, wherein the at least one processor further causes the electronic apparatus to receive a first operation as the first instruction and a second operation that is an operation method different from the first operation as the second instruction.

4. The electronic apparatus according to claim 1, wherein, in the second operation mode, the at least one processor further causes the electronic apparatus to communicate with the second communication destination based on satisfaction of a predetermined condition even without the communication instructing operation by the user after the second instruction.

5. The electronic apparatus according to claim 4, wherein the predetermined condition is a condition relating to a time.

6. The electronic apparatus according to claim 5, wherein the predetermined condition is at least one of a lapse of a predetermined period, an arrival of a predetermined time point, or a continuation of a no-operation state for a predetermined time.

7. The electronic apparatus according to claim 1, wherein, in the second operation mode, the processor further causes the electronic apparatus to communicate with the second communication destination based on a startup of the second operation mode even without the communication instructing operation by the user after the second instruction.

8. The electronic apparatus according to claim 1, wherein the processor further causes the electronic apparatus to acquire information indicating whether there is a piece of firmware of a version newer than current firmware of the electronic apparatus via the communication with the second communication destination in the second operation mode.

9. The electronic apparatus according to claim 8, wherein, in a case where the information indicating presence of the firmware of a new version is acquired, the processor further causes the electronic apparatus to display a screen for confirming whether to update the firmware, and in a case where an execution instructing operation of the firmware update by the user is received in a state where the screen is displayed, to perform processing for updating the firmware to the firmware of the new version.

10. The electronic apparatus according to claim 9, wherein the processor further causes the electronic apparatus to display the screen at at least one of a timing when the information indicating the presence of the firmware of the new version is acquired or a timing corresponding to an operation for turning off the apparatus.

11. The electronic apparatus according to claim 8, wherein, in a case where the information indicating the presence of the firmware of the new version is acquired, the processor further causes the electronic apparatus to perform processing for updating the firmware to the firmware of the new version based on a predetermined non-operation period.

12. The electronic apparatus according to claim 1, further comprising a printer configured to perform printing on a sheet.

13. The electronic apparatus according to claim 12, wherein, in the second operation mode, the processor further causes the electronic apparatus to perform a printing corresponding to a print instruction from at least one information processing apparatus of a third communication destination connected to a same access point, a fourth communication destination connected via wireless direct connection, or a fifth communication destination connected via a universal serial bus cable, or processing for performing a scan and transmitting scan data to the at least one information processing apparatus.

14. The electronic apparatus according to claim 13, wherein communications with the third to fifth communication destinations is a communication different from HyperText Transfer Protocol (HTTP) communication.

15. The electronic apparatus according to claim 1, wherein the first communication destination is a communication destination to be communicated for use of a function using a web service.

16. The electronic apparatus according to claim 1, wherein, in the second operation mode, the processor further causes the electronic apparatus to limit HTTP communication with the first communication destination and to perform the HTTP communication with the second communication destination.

17. The electronic apparatus according to claim 1, wherein, in the second operation mode, a network setting is changeable.

18. The electronic apparatus according to claim 1,
wherein the processor is further configured to receive a third instruction for enabling a third operation mode, and
wherein, in the third operation mode, the processor further causes the electronic apparatus not to communicate with the second communication destination.

19. A method of controlling an electronic apparatus, the method comprising:
receiving a first instruction for enabling a first operation mode and a second instruction for enabling a second operation mode; and
performing, in the first operation mode even without a communication instructing operation by a user after the first instruction, control to communicate with a first communication destination and to control to communicate with a second communication destination for a firmware update, and
perform, in the second operation mode, control to restrict the communication with the first communication destination and to control to communicate with the second communication destination even without the communication instructing operation by the user after the second instruction.

20. A non-transitory computer-readable storage medium storing one or more programs configured to cause one or more computers to execute a method, the method comprising:
receiving a first instruction for enabling a first operation mode and a second instruction for enabling a second operation mode; and
performing, in the first operation mode even without a communication instructing operation by a user after the first instruction, control to communicate with a first communication destination and control to communicate with a second communication destination for a firmware update, and
performing, in the second operation mode, control to restrict the communication with the first communication destination and control to communicate with the second communication destination even without the communication instructing operation by the user after the second instruction.
